(19) United States
(12) Patent Application Publication
(10) Pub. No.: US 2021/0093972 A1
(43) Pub. Date: Apr. 1, 2021

(54) System and Method for Toy Vehicle Design and Development

(71) Applicant: Thoughtfull Toys, Inc., Santa Cruz, CA (US)

(72) Inventors: David Eugene Silverglate, Santa Cruz, CA (US); Cyril Brian Gulassa, Berkeley, CA (US); Yusheng Deng, Kanuma City (JP); Jonathan David Stallings, Felton, CA (US)

(73) Assignee: Thoughtfull Toys, Inc., Santa Cruz, CA (US)

(21) Appl. No.: 16/583,519

(22) Filed: Sep. 26, 2019

(51) Int. Cl. A63F 13/63; G06Q 30/06; A63F 13/803; A63F 13/85; A63H 17/00

(52) U.S. Cl. CPC A63F 13/63; G06Q 30/0621; A63H 17/00; A63F 13/85; A63F 13/803

(57) ABSTRACT

A method comprises sending to a computer processor a log-in identifier to access a virtual garage stored in an online database. The virtual garage can contain computer code representing at least one vehicle stored in the virtual garage, and the vehicle being comprised of a plurality of components. Instructions can be sent to the computer processor from the first party to display the at least one vehicle in the virtual garage. A replacement component for at least one of the plurality of components is selected and sent by the first party to the computer processor, along with instructions to replace the component with the replacement component to create a new vehicle. Once the new vehicle is created, it can be displayed on the end user device.

### CROSS REFERENCE TO RELATED APPLICATIONS

This application is related to U.S. application Ser. No. 14/503,290 titled Interactive Toy Vehicle System, and listing as inventors David E. Silverglate and Brian Gulassa, the contents of which are hereby incorporated by reference in their entirety.

### BACKGROUND

In today's marketplace, young consumers have come to expect a level of online interactivity with their entertainment goods. Video games routinely allow players to customize their characters online according to their preferences, social media sites allow users such as end users to customize features of their personal pages, and online communities often feature avatars whose features can be customized in countless different ways and made unique to each user. Thus, young consumers have come to desire the same degree of interactivity with their physical toys as well, including toy vehicles. Unfortunately, no means exist for custom creating a toy vehicle and making it part of an online world where users can display their custom creations, or drive, race or otherwise use their custom toy vehicles as part of an online world. In addition, no means exist for custom creating a toy vehicle, whether physical or virtual, and using that vehicle as part of real-world interactions.

Thus, a need exists for young consumers to be creatively involved in the actual creation of the toy vehicle and take ownership of the design of the toy vehicle, as well as share their creations as part of an online community.

### SUMMARY

In an embodiment, a method includes sending by a first party to a computer processor, a log-in identifier to access a virtual garage stored in an online database, the virtual garage containing computer code representing at least one vehicle stored in the virtual garage, the at least one vehicle being comprised of a plurality of components. The first party sends to the computer processor a request to display the at least one vehicle in the virtual garage, and a request for a replacement component for at least one of the plurality of components. The first party instructs the computer process to replace the at least one of the plurality of components with the replacement component to create a new vehicle. The new vehicle can then be displayed, purchased shared, raced, or otherwise used to interact with a virtual world.

In another embodiment, a method includes receiving, at a computer processor, a log-in identifier to access a virtual garage stored in an online database, the virtual garage containing computer code representing at least one vehicle stored in the virtual garage, a vehicle segmented into a plurality of components. The computer processor sends instructions to display the vehicle on a first party's display, and receives instructions to replace at least one of the segments. The processor then replaces the segment with the replacement segment, creating a new vehicle, and then displays the new vehicle. The new vehicle can be saved, it can be moved into a workflow for purchase, and/or it can be shared.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a system for providing a virtual garage and online toy vehicle configurator, according to an embodiment of the invention.

FIG. 2 is a flow chart of a process for online customization of a virtual vehicle, component, and/or subcomponent, or real toy vehicle by an end user, according to an embodiment of the invention.

FIG. 3 is a flow chart of a process for an end user to interact with a virtual world using a virtual vehicle, component, and/or subcomponent, according to an embodiment of the invention.

FIG. 4 is a flow chart of a process for providing online customization services for a virtual vehicle, component, and/or subcomponent, or a real toy vehicle.

FIG. 5 is a flow chart for providing virtual world interaction with a virtual vehicle, component, and/or subcomponent, according to an embodiment of the invention.

FIG. 6 is a flow chart of a process for online creation and customization of a virtual racetrack, component, or subcomponent, for interaction with a virtual world, according to an embodiment of the invention.

FIG. 7 is a flow chart of a process for an end user to interact with a virtual world using a virtual racetrack, according to an embodiment of the invention.

FIG. 8 is a flow chart of a process for an end user to display a vehicle, component, or subcomponent on a menu, according to an embodiment of the invention.

FIG. 9 is a flow chart that describes randomly generating equipment (a vehicle, component, or subcomponent), according to an embodiment.

### DETAILED DESCRIPTION

One or more of the systems and methods described herein describe a way of providing a toy vehicle customization system. As used in this specification, the singular forms “a” “an” and “the” include plural referents unless the context clearly dictates otherwise. Thus, for example, the term “a computer server” or “server” is intended to mean a single computer server or a combination of computer servers. Likewise, “a processor,” or any other computer-related component recited, is intended to mean one or more of that component, or a combination thereof. One skilled in the art will understand that a web page is a document on the Internet, and that a website comprises one or more web pages that are linked together.

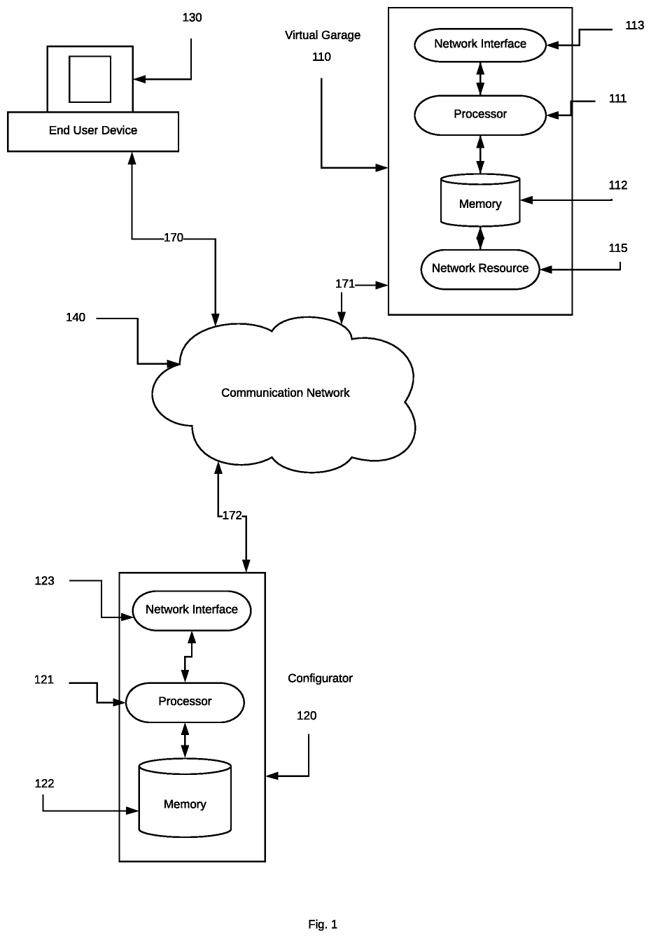

FIG. 1 is a block diagram of a system for providing a virtual garage and online toy vehicle configurator, according to an embodiment of the invention. One skilled in the art will understand that the term “garage” is used in its generic sense as a place where vehicles can be stored. Thus, it can include “structure,” “hangar,” “parking lot,” “dock,” “dry dock,” “harbor,” and any other suitable place where vehicles can be stored. This embodiment comprises end user device 130, virtual garage 110 and configurator 120. Configurator 120 is configured to provide a design menu, and to process instructions to create or alter a vehicle, component, and/or sector within a component. One skilled in the art will understand that the term vehicle can include “car,” “motorcycle,” “truck,” “snowmobile,” “construction vehicle,” “airplane,” “spaceship,” “boat,” or any other suitable vehicle. In an embodiment, virtual garage 120, end user device 130, and configurator 110 are operatively coupled to one another through communication network 140 via network connection 170, which connects end user device 130 to communication network 140, network connection 171, which connects virtual garage 110 with communication network 140, and network connection 172, which connects configurator 120 with communication network 140.

Network connections 170, 171, and 172 can be any practicable network connection, physical, wireless, or otherwise, or any combination thereof, for operatively coupling end user device 130, virtual garage 110, and configurator 120 to communication network 140.

Communication network 140 can be any communications network configurable to allow each of the network elements HO, 120, and 130, to communicate with or to other network elements through communication network 140. Communication network 140 can be any network or combination of networks capable of transmitting information data and/or signals) and can include, for example, a telephone network, an Ethernet network, a fiber-optic network, a wireless network, and/or a cellular network. In some embodiments, communication network 140 can include multiple networks operatively coupled to one to another by, for example, network bridges, routers, switches and/or gateways. For example, end user device 130 can be operatively coupled to a cellular network, configurator 120 can be operatively coupled to an Ethernet network, and virtual garage 110 can be operatively coupled to a fiber-optic network. The cellular network, Ethernet network and fiber optic network can each be operatively coupled one to another via one or more network bridges, routers, switches and/or gateways such that the cellular network, the Ethernet network and the fiber-optic network are operatively coupled to form a communication network. Alternatively, for example, the cellular network, the Ethernet network, and the fiber-optic network can each be operatively coupled to the Internet such that the cellular network, the Ethernet network, the fiber-optic network and the Internet are operatively coupled to form a communication network.

In some embodiments, a network connection can be a wireless network connection such as, for example, a wireless fidelity (“Wi-Fi”) or wireless local area network (“WLAN”) connection, a wireless wide area network (“WWAN”) connection, and/or a cellular connection. In some embodiments, a network connection can be a cable connection such as, for example, an Ethernet connection, a digital subscription line (“DSL”) connection, a broadband coaxial connection, and/or a fiber-optic connection. In some embodiments, an end user device, partner application and/or virtual garage can be operatively coupled to a communication network by heterogeneous network connections. For example, an end user device can be operatively coupled to the communication network by a WWAN network connection, a partner application can be operatively coupled to the communication network by a DSL network connection, and a virtual garage can be operatively coupled to the communication network by a fiber optic network connection. In some embodiments, the data flowing across the network connections and communications network flow through a physical connection from one element to another.

Configurator 120 acts as the engine for configuring vehicles, components, and subcomponents of components in the virtual garage. For the purposes of the present invention, subcomponents of components can also be called “sectors.” In an embodiment, memory 122 stores in computer code some or all of the following: colors; shapes; decals; unconfigured vehicles, components, and sectors; preconfigured vehicles, components, and sectors; instructions to customize vehicles, components, and sectors.

In an embodiment, processor 121 of configurator 120 is configured to process instructions to configure vehicles, components, and sectors. In an embodiment, processor 121 is configured to process instructions to provide a design menu to be displayed on end user device 130. In an embodiment, processor 121 is configured to receive configuration instructions, access information from memory 122, and to send, through network interface 124, the configured and/or selected vehicle, component, or sector.

In an embodiment, configurator 120 comprises a network interface 123, a processor 121, and a memory 122. Configurator 120 is operatively coupled to end user device 130 and virtual garage 110 through communication network 140 via network connection 172. End user device 130 is connected to analysis system 120 through communication network 140 via network connection 170, and virtual garage 110 is operatively coupled to end user device 130.

In an embodiment, network interface 123 can be any network interface configurable to be operatively coupled to communication network 140 via network connection 172. For example, a network interface can be a wireless interface such as, for example, a worldwide interoperability for microwave access (“WiMAX) interface, a high-speed packet access (“HSPA”) interface, and/or a WLAN interface. A network interface can also be, for example, an Ethernet interface, a broadband interface, a fiber-optic interface, and/or a telephony interface.

In an embodiment, both the virtual garage 110 and configurator 120 can be based on any combination of hardware and software. In an embodiment, virtual garage 110 includes network interface 113, processor 111, memory 112, and network resource 115. Virtual garage 110 is operatively coupled to communication network 140 via network interface 113 and network connection 171. Network interface 113 can be any network interface configurable to be operatively coupled to communication network 140 via network connection 171. For example, a network interface can be a wireless interface such as, for example, a worldwide interoperability for microwave access (“WiMAX) interface, a high-speed packet access (“HSPA”) interface, and/or a WLAN interface. A network interface can also be, for example, an Ethernet interface, a broadband interface, a fiber-optic interface, and/or a telephony interface.

The contents of virtual garage 110 are stored as data in memory 112. In an embodiment, some or all of the contents stored in virtual garage 110 are purely virtual (that is, they do not represent any real-world vehicle, component, or sector), while some of the contents stored in virtual garage 110 represent real-world toy vehicles (in other words, tangible toys, as opposed to virtual toys), components, or sectors that can be manufactured, bought, sold, and shipped to an end user. In an embodiment, memory 112 includes data for rendering a virtual world in which the contents of the virtual garage can interact. In an embodiment, memory 112 includes virtual vehicles that can be used to interact within a virtual world. The virtual world can be an online representation of a world that can include some combination of vehicles, virtual garages, vehicle shows (such as car shows, airplane shows, monster truck rallies, regattas, war games, and others), racetracks, races, space stations, outer space, construction sites, and others.

In an embodiment, processor 111 of virtual garage 110 can process instructions to render, display, create, alter, select, purchase, and store some or all of the contents of virtual garage 110. Processor 111 is operatively coupled to network interface 113 such that processor 111 can be configured to be in communication with communication network 140 via network interface 113. In an embodiment, processor 111 (and processor 121) can be any of a variety and combination of processors, and can be distributed among various types and pieces of hardware, or even across a network. Such processors can be implemented, for example, as hardware modules such as embedded microprocessors, microprocessors as part of a computer system, Application Specific Integrated Circuits (“ASICs”), and Programmable Logic Devices (“PLDs). Some such processors can have multiple instruction executing units or cores. Such processors can also be implemented as one or more software modules in programming languages as Java, C++, C, assembly, a hardware description language, or any other Suitable programming language. A processor according to some embodiments includes media and program code (which also can be referred to as code) specially designed and constructed for the specific purpose or purposes.

Processor 111 is also operatively coupled to memory 112 which, in an embodiment, can be used to store, in computer code, virtual vehicles, virtual vehicle components, a catalog of virtual vehicles, a catalog and/or register of virtual vehicle components and/or sectors, an online world, ecommerce functionality, user account information, login information, a username, a password, keyword landscapes, web pages, searches, search results, cookie and other identifying information, and any other data necessary for configurator 120 to perform at least a part of the invention. In an embodiment, memory 112 (and memory 122) can be a read-only memory (“ROM”); a random-access memory (RAM) such as, for example, a magnetic disk drive, and/or solid-state RAM such as static RAM (“SRAM) or dynamic RAM (“DRAM), and/or FLASH memory or a solid-data disk (“SSD), or a magnetic, or any known type of memory. In some embodiments, a memory can be a combination of memories. For example, a memory can include a DRAM cache coupled to a magnetic disk drive and an SSD.

In addition to memories 112 and 122, some embodiments include another processor-readable medium (not shown in FIG. 1) having instructions or program code thereon for performing various processor-implemented operations. Examples of processor-readable media include, but are not limited to: magnetic storage media such as hard disks, floppy disks, and magnetic tape; optical storage media Such as Compact Disc/Digital Video Discs (“CD/DVDs), Compact Disc-Read Only Memories (“CD-ROMs), and holographic devices: magneto-optical storage media such as floptical disks; Solid state memory such as SSDs and FLASH memory; and ROM and RAM devices. Examples of program code include, but are not limited to, micro-code or micro-instructions, machine instructions (such as produced by a compiler), and files containing higher-level instructions that are executed by a computer using an interpreter. Program code can include hardware, software, firmware, and any practical way of coding. For example, an embodiment may be implemented using HTML, Java, C++, or other object-oriented programming language and development tools. Additional examples of program code include, but are not limited to, control signals, encrypted code, and compressed code.

In some embodiments, virtual garage 110 can be implemented in program code such as, for example, a virtual machine executing on or in a processor. For example, a virtual garage can be a software module executing in a virtual machine environment such as, for example, a Java module executing in a Java Virtual Machine (“JVM), or an operating system executing in a VMware virtual machine. In some embodiments, a network interface, a processor, and a memory are virtualized and implemented in program code executing in, or as part of, a virtual machine.

Likewise, processor 121 is operatively coupled to network interface 123 such that processor 121 can be configured to be in communication with communication network 140 via network interface 123. Processor 121 is also operatively coupled to memory 122 which, in an embodiment, can be used to store keyword configurator data including (but not limited to) vehicle components, colors, stickers, decals, shapes, instructions to create and substitute a variety of vehicle components, subcomponents (also called sectors), landscapes, airscapes, seascapes, program code, analytics, web pages, searches, search results, and any other data necessary for configurator 120 to perform at least a part of the invention.

In some embodiments, a configurator can be a virtual device implemented in program code such as, for example, a virtual machine executing on or in a processor. For example, an configurator can be a software module executing in a virtual machine environment such as, for example, a Java module executing in a Java Virtual Machine (“JVM), or an operating system executing in a VMware virtual machine. In some embodiments, a network interface, a processor, and a memory are virtualized and implemented in software executing in, or as part of, a virtual machine.

As illustrated in FIG. 1, virtual garage 110 includes network resource 115. Network resource 115 can be, for example, a web server and/or database accessible over communication network 140. Network resource 115 is configured to, for example, send a web page, virtual vehicle data, rendering data, or other data formatted in hypertext markup language (“HTML”) or other languages to end user device 130, which user device 130 can display to an end user.

In some embodiments, a network resource can include a database configured to process database queries received by a virtual garage over a communication network. In some embodiments, a network resource can exchange encoded binary data, such as images, videos, and/or documents, for example, with an end user device over a communication network. In some embodiments, a network resource can include a database configured to process database queries received by virtual garage 110 over communication network 140. In some embodiments, a network resource can exchange encoded binary data, such as images, videos, and/or documents, for example, with an end user device over a communication network.

One skilled in the art will understand that the constituent parts of virtual garage 110 and configurator 120 can overlap, can or can be distinct. For example, configurator 120 and virtual garage 110 can share a processor, a memory, and/or a network interface. In an embodiment, end user device 130 can be a personal computer or laptop or smart television. In another embodiment, end user device 130 can be a mobile device such as a mobile telephone or a tablet computer. In addition, one skilled in the art will understand that the embodiments described herein can be practiced in a SaaS environment, or in any environment suitable for the components and methods described herein.

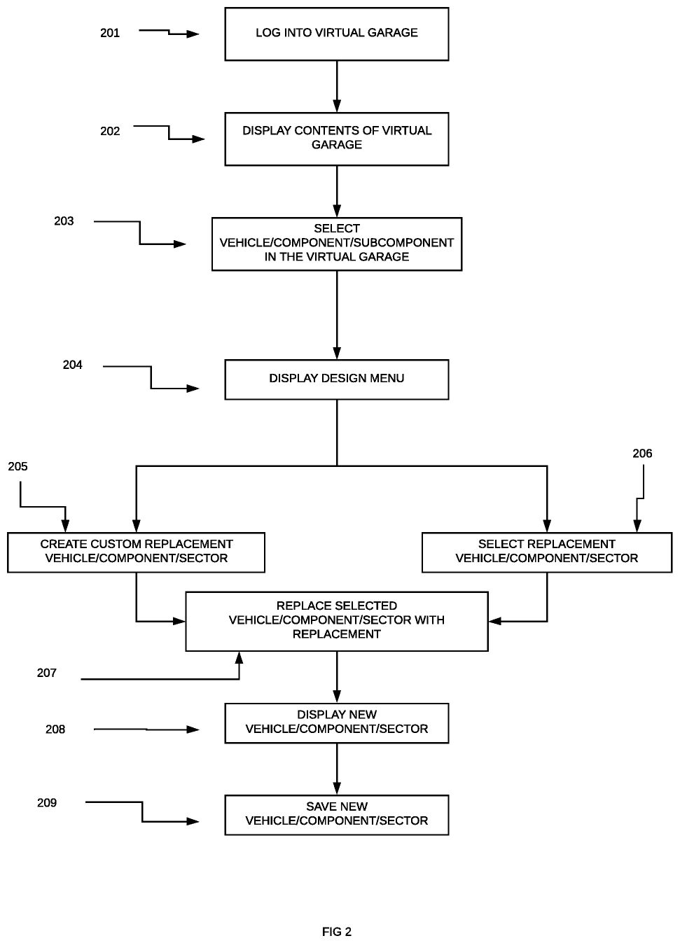

FIG. 2 is a flow chart of a process for online customization of a virtual vehicle or real toy vehicle by an end user, according to an embodiment. One skilled in the art will understand that the term car can be extended in appropriate embodiments to include other vehicles such as motorcycles, trucks, construction vehicles, boats, airplanes, and spaceships. In addition, embodiments of the invention can include buildings and other structures in lieu of vehicles. In one embodiment, the process in FIG. 2 is implemented by at least a subset of components in the virtual garage and configurator system. At 201, an end user (also known as a first party) logs into the end user's virtual garage from an end user device. In an embodiment, the end user logs into the virtual garage by accessing a URL or web page of the virtual garage and then inputting login credentials such as a username and/or password. In an embodiment, the login credentials can include a registration plate number unique to the end user or to an end user vehicle. One skilled in the art will understand that the term “registration plate” can be instantiated differently for different types of vehicles, and can be a plate or a sticker or paint, or any other practicable way of implementing the registration plate. As examples, but not the only examples, a registration plate can be a car license plate, an airplane registration number or name, a boat registration number or name, or a spaceship registration number or name. In an embodiment, the login credentials can include some other identifier identifying which garage the user is logging in to. At 202, the contents of the virtual garage are displayed on the end user device. In one embodiment, the contents of the virtual garage are displayed automatically by the virtual garage in response to the virtual garage receiving the proper login credentials. In another embodiment, the contents of the virtual garage are displayed in response to instructions sent by the end user through an end user GUI.

The virtual garage can include data representing some or all of the vehicles, components, and sectors, owned and or saved by the end user. In an embodiment, at 203, the end user can send instructions selecting a vehicle, component, or subcomponent within the virtual garage. If a vehicle in the garage is selected, the user should be able to further select a component or subcomponent. For example, if a car is chosen, the user should be able to then work on the entire car, or select a component such as a chassis.

The vehicle, component, or subcomponent can be owned by the end user, or in another embodiment the vehicle can be saved by the end user prior to purchase. In another embodiment, the vehicle can be owned by a different (second or third) party. In another embodiment, a preconfigured or preselected virtual vehicle, component, or sector can be selected.

At 204, a design menu is displayed on the end user device. In an embodiment, the design menu is represented by a GUI on the end user device. In an embodiment, the design menu includes preconfigured or preselected vehicle, components, and sectors from which the end user can select. In an embodiment, the design menu includes a selection of colors, shapes, stickers, and other ways to decorate, adorn, or otherwise alter, the vehicles, components, and sectors found on the menu. Using the design menu, in an embodiment, the end user can modify the preconfigured or preselected vehicle, component, or sector.

Once a vehicle, component, or sector is selected, in an embodiment, at 205, the end user can use the design menu to create a custom replacement for the selected vehicle, component, or sector. In an embodiment, the design menu can be used to provide a vehicle, component, or sector, and the end user can select the color, decorations, adornments, and shape. In an embodiment, the end user can use the design menu to select a pre-shaped vehicle, component, or sector, and can alter the shape of the pre-shaped vehicle, component, or sector.

In another embodiment, at 206, a preconfigured replacement vehicle, component, or sector can be selected from the design menu. The replacement component can be used in its preconfigured form, or can be altered by the end user for further customization.

Once a replacement vehicle, component, or sector is decided upon, then at 207, the user can “lock in” the selection, thereby creating a new vehicle, and can send a request at 208 to display the new vehicle, component, or sector, on the end user device. In an embodiment, if the end user finds the new vehicle, component, or sector satisfactory, the end user can send instructions to save the new vehicle, component, or sector, at 209.

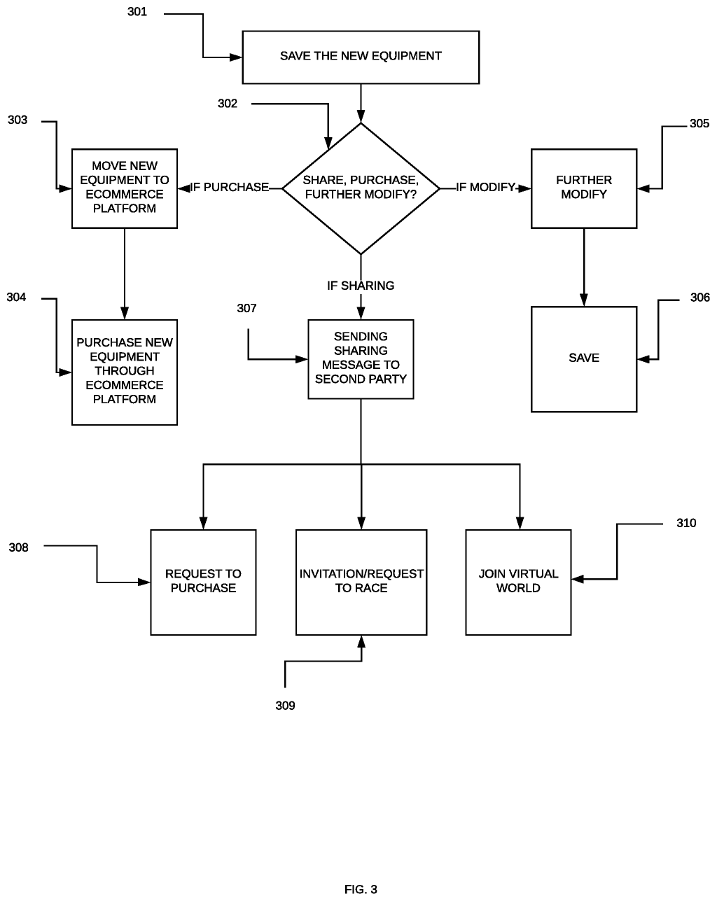

FIG. 3 is a flow chart of a process for an end user to interact with a virtual world using a virtual vehicle, according to an embodiment of the invention. In an embodiment, at 301, the new vehicle, component, or sector, also called the modified vehicle, component, or sector, is saved. At 302, the user makes a decision as to whether the new vehicle, component, or sector should be shared, purchased, or further modified, or some subset of sharing, purchasing and further modifying. If the end user decides to purchase the new vehicle, component, or sector, then at 303, instructions are sent to send the new vehicle, component, or sector (called the “new equipment” in FIG. 3, which depending on the context, can refer to a new vehicle, new component, or new sector) to an ecommerce platform coupled to the virtual garage and/or the configurator. In an embodiment, a user can choose to purchase and purchase a 3-D file of a vehicle, component, or sector. In an embodiment, a user can choose to have the vehicle represented by a 3-D file painted and decorated before shipping, or before rendering. In an embodiment, the ecommerce platform includes a virtual shopping cart for purchase. At 304, the end user can input instructions to purchase the new equipment, along with payment and other information. In an embodiment, a virtual new vehicle, component, or sector can be purchased as a physical vehicle, component, or sector.

If the end user decides to further modify the new vehicle, component, or sector, in an embodiment, then at 305, the design menu can be accessed, and the user can again go through the steps of configuring the new vehicle, component, or sector. Once the new vehicle, component, or sector has been further modified to the end user's liking, then at 306, the end user can save the new vehicle, component, or sector. Of course, one skilled in the art will understand that such vehicle, component, or sector (each virtual or otherwise) can also be purchased, at 304.

If the end user decides to share the new vehicle, component, or sector, at 307, a message is created and sent to a second party concerning the sharing. If an end user desires to share the new vehicle, component, or sector with a second party with a request that the second party purchase the new vehicle, component, or sector, then in an embodiment at 308, the message is sent requesting such a purchase. In an embodiment, the message sent to the second party can include instructions to access the vehicle online. In an embodiment, the message sent to the second party can include a representation of the vehicle in the message. A message can be an email message, an SMS or text message, or any known type of electronic message.

In an embodiment, the end user decides to race the new vehicle, and can send a message to the second party, at 309, requesting a race. In an embodiment, the message includes an invitation to race the new vehicle against another vehicle on a virtual track or otherwise in a virtual world. In an embodiment, the message includes a request to race the vehicle on a specific virtual track or path in the virtual world. In an embodiment, at 310, the end user can send a message to a second party requesting to join a virtual world, or inviting the second party to join the end user's virtual world. In an embodiment, a virtual world includes a world designed as part of a video game.

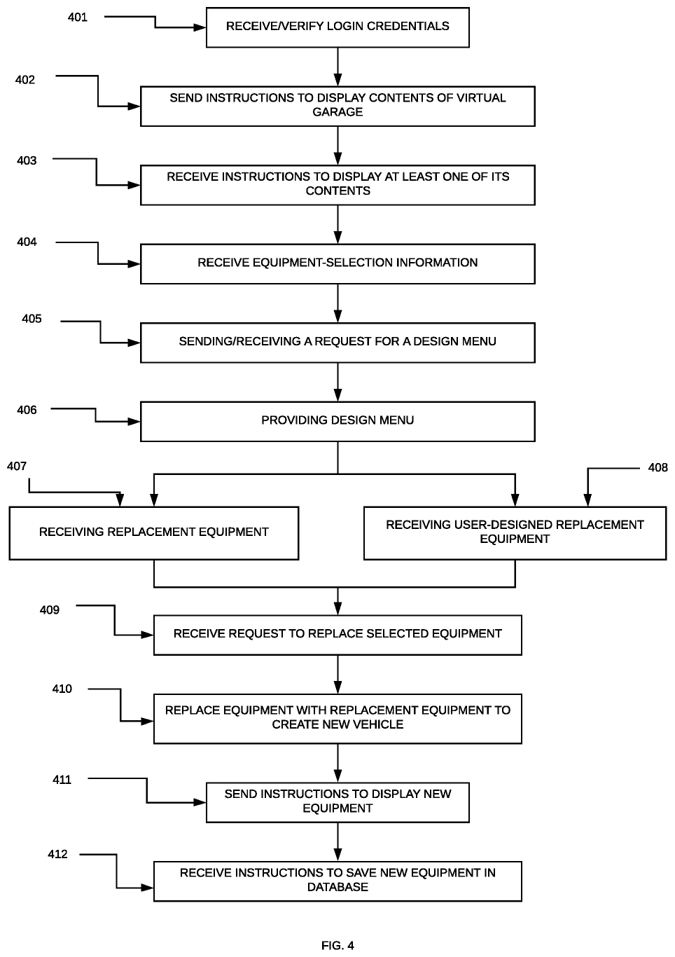

FIG. 4 is a flow chart of a process for providing online customization services for a virtual vehicle or a toy vehicle. At 401, login credentials are received at a processor and verified. In an embodiment, login credentials include a login identifier such as a username. In an embodiment, login credentials can include a registration plate number unique to a virtual vehicle. The virtual garage can be password protected, and in an embodiment, the login credentials include a password. Once received, the login credentials are verified by a processor in a virtual garage. In an embodiment, once the end user is logged in, at 402 the processor sends instructions to display the contents of the virtual garage. The contents can include a virtual vehicle, a virtual vehicle that represents a physical vehicle, a component of a virtual vehicle, a sector of the virtual vehicle's component, and/or different types of ornamentations.

At 403, in an embodiment, the processor receives instructions to display at least one of its contents. In an embodiment, the processor receives instructions to display at least one of a vehicle, a component, and/or a sector. For example, in an embodiment, the processor receives instructions to display one or more of the vehicles owned by the end user. In another embodiment, the processor receives instructions to display one or more of the components owned by the end user. Alternatively, in an example, the processor receives instructions to display all or any subset of all of the contents of the virtual garage.

At 404, the processor receives information that an end user has selected a vehicle, component, or sector (called the “equipment” in FIG. 4, which depending on the context, can refer to a vehicle, component, or sector found in the virtual garage). Then, in an embodiment, at 405, the processor receives a request to provide a design menu to the end user. In an embodiment, at 405, the processor sends a request to the design menu to be provided to the end user. In an embodiment, the sent request can be in response to the component or sector selection.

At 406, the design menu is provided to the end user. In an embodiment, a configurator processor in the configurator provides the design menu to the end user via a communication network. At 407, in an embodiment, the virtual garage processor receives replacement equipment selected from one or more devices provided with the design menu. In an embodiment, at 408, the virtual garage processor receives user-designed replacement equipment that was designed using the design menu on the end user device.

In an embodiment, at 409, the virtual garage processor receives a request to replace the selected equipment with the replacement equipment. The virtual garage processor, at 410, processes the changes to the equipment and replaces the selected equipment, thus creating new equipment. In an embodiment, at 411, the virtual garage sends instructions to the end user device to display the new equipment on the end user device. In an embodiment, at 411, the replaced equipment is a component or sector, and the virtual garage sends instructions to the end user device to display the new vehicle that includes the new replacement component or sector. In an embodiment, the replaced equipment is a sector, and the virtual garage sends instructions to the end user device to display the new component that includes the replacement sector. At 412, in an embodiment, the virtual garage processor receives instructions from the end user to save the new equipment in the virtual garage database.

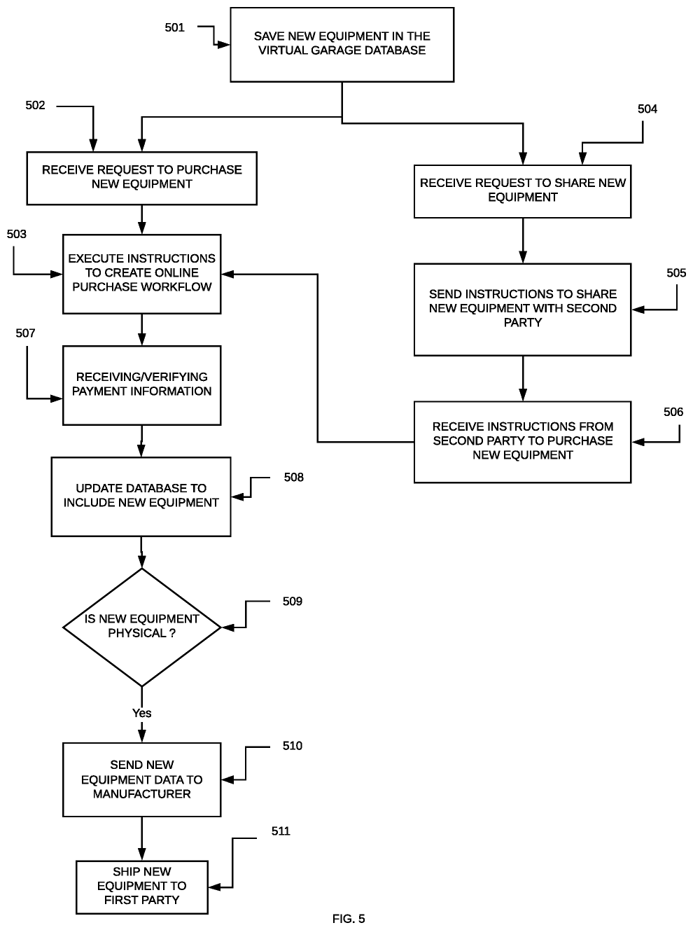

FIG. 5 is a flow chart for providing virtual world interaction with a virtual vehicle, according to an embodiment of the invention. At 501, the processor processes instructions to save a new vehicle, new component, or new sector (again, referred to as “new equipment,” depending on the context), in the virtual garage database. Once the equipment is instantiated in data, one or several actions may be taken. In an embodiment, at 502, the virtual garage processor receives a request to purchase the new equipment. In an embodiment, the request can be received from the end user (the first party). In another embodiment, the request can be received from a different party. At 503, the processor can execute instructions to execute an online purchase workflow. In an embodiment, the online purchase workflow is an ecommerce workflow that can include a virtual shopping cart, online payment instructions, and online acceptance.

In an embodiment, at 504, the processor receives a request to share the equipment with a second party. At 505, the processor sends instructions to share the equipment with the second party. The new equipment can be shared for viewing, for racing, or for further modification. In an embodiment, the instructions include instructions to create an online message requesting that the second party purchase the new car for the first party. In an embodiment, at 506, the virtual garage processor receives instructions from the second party to purchase the new equipment, and the new equipment is moved into the online purchase workflow at 503.

Once payment information is received and verified at 507, in an embodiment, the processor sends instructions to update the virtual garage database to include the new equipment. At 508, the databased is updated to include the new equipment. In an embodiment, the database can be updated to include a unique identifier for the new equipment. For example, the unique identifier can include a registration plate number unique to the vehicle. One skilled in the art will understand that the registration plate number can include any combination of numbers, letters, and/or other characters.

In an embodiment, the virtual garage processor, at 509, determines whether the new equipment is purely virtual, or whether the new vehicle, new component, or new sector is intended to be turned into a physical toy vehicle, component, or sector, and whether it should be sent to the end user. If the virtual garage processor determines, or receives instructions, that the new equipment is intended to represent or be turned into a physical toy vehicle, component, or sector, then at 510, the virtual garage processor sends data to a toy vehicle manufacturer to manufacture the physical toy vehicle, component, or sector, and at 511, the physical toy vehicle, component, or sector, is shipped to the end user.

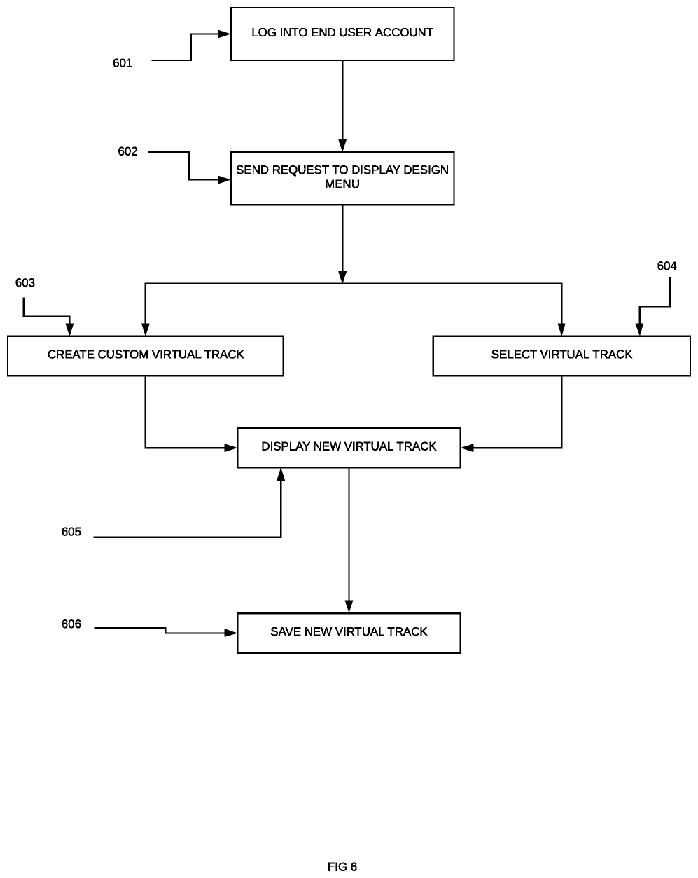

Any virtual vehicle can be used to interact in certain ways with a virtual world, and in an embodiment, an end user can use the design menu to create certain aspects of that world. For example, but not the only example, in an embodiment, an end user can use the design menu to select a preconfigured racetrack for a virtual car race, that is, a car race that is represented in computer code, rather than with physical bodies. In another embodiment, an end user can use the design menu to create a new racetrack. In an embodiment, an end user can use the design menu to create a new racetrack out of track components provided by the configurator and displayed as part of the design menu to the end user. FIG. 6 is a flow chart of a process for online creation and customization of a virtual racetrack for interaction with a virtual world, according to an embodiment of the invention. One skilled in the art will understand that the term “racetrack” is not limited to a car racetrack; the term “racetrack” can include any appropriate racing path for any vehicle. At 601, an end user can send instructions to be received by a processor to log into his or her account. The account can manifest itself as a virtual garage, a virtual world, or in any way specific to the end user's account. At 602, the end user can send a request to display a racetrack design menu on the end user device, and a processor, upon receiving that request, can send instructions to display the racetrack design menu on the end user device. In an embodiment, the request can be sent to the user's account for forwarding to a racetrack configurator. In another embodiment, the request can be sent directly to the racetrack configurator through a communications network. The racetrack configurator can then communicate with both the end user and the user account.

In the design menu, at 603, the user can select from a number of shapes, sizes, colors, and other factors displayed on the end user device in the design menu to create a complete virtual racetrack, or to create a portion of a virtual racetrack, also called a virtual racetrack component or a virtual racetrack subcomponent (sector), as the case may be. For the purposes of the present invention, the term “virtual track” or “virtual racetrack” will mean one of, all of, or some subset of, the following: the virtual racetrack, the virtual racetrack component, and the virtual racetrack subcomponent. One skilled in the art will understand that context will dictate what is meant by virtual track. In an embodiment, once the end user has selected the virtual track, it can send instructions to the processor to, in an embodiment, place a virtual racetrack component into an existing virtual racetrack as a new component, or as a replacement component for a component within the track. In an embodiment, at 604, an end user can select a complete finished virtual racetrack for virtual vehicle racing in the virtual world. In another embodiment, at 604, an end user can select a finished virtual racetrack component for placement into an existing virtual racetrack, either as a new component or as a replacement component. In another embodiment, at 604, an end user can select a finished virtual racetrack sector for placement into an existing virtual racetrack, either as a new sector or as a replacement sector. In an embodiment, a virtual racetrack sector can be any combination of textures, colors, track surfaces, or embellishments for a virtual racetrack component.

At 605, the processor can process instructions to display the virtual track, either as a standalone piece, or as part of a component of a virtual racetrack or a complete virtual racetrack.

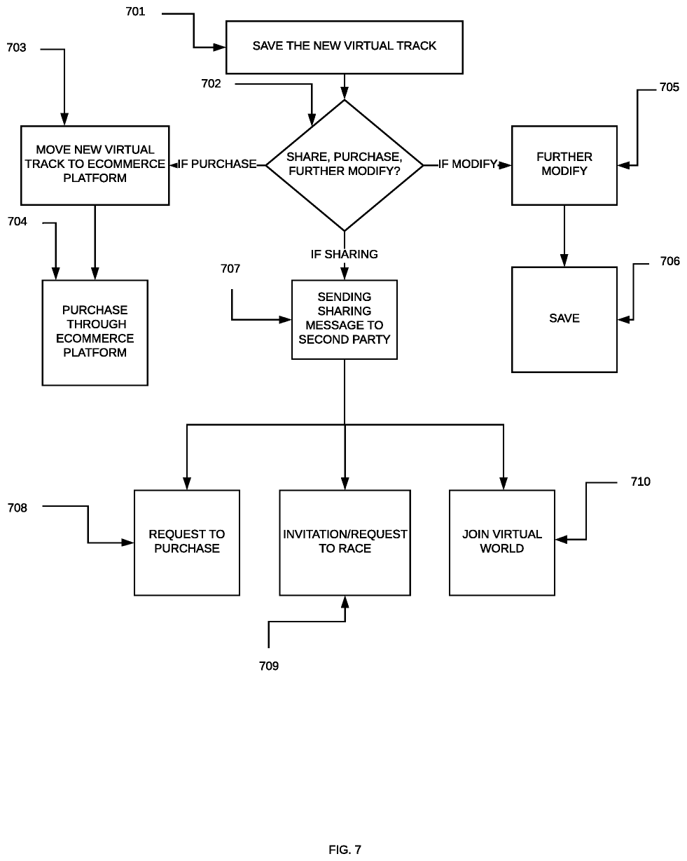

As in the case of the virtual vehicle, the virtual track can be saved, purchased, shared, and modified. FIG. 7 is a flow chart of a process for an end user to interact with a virtual world using a virtual racetrack, according to an embodiment of the invention. At 701, after being selected and/or modified, as the case may be, the virtual track can be saved to the end user's account. At 702, a decision can be made to share, purchase, or further modify the virtual track. If the decision is made to purchase the virtual track, in an embodiment at 703, the virtual track is moved to an ecommerce platform where it can be purchased, at 704, in any practicable way through the ecommerce platform.

If the decision is made to further modify the virtual track, then in an embodiment, at 705, the virtual track is further modified, and then is saved to the user's account at 706. In an embodiment, if an end user desires to share the new virtual track, then in an embodiment, at 707, the user can send instructions to create a message to a second party in which the new virtual track is shared with the second party. An end user may share for any number of reasons. In an embodiment, the sharing message sent at 707 may include a request from, for example, a parent or grandparent, to purchase the new virtual track on behalf of the end user, at 708. In an embodiment, the sharing message sent at 707 can include, at 709, an invitation or request to race on the virtual track. In an embodiment, at 710, the message can include a request to include the virtual track in a virtual world.

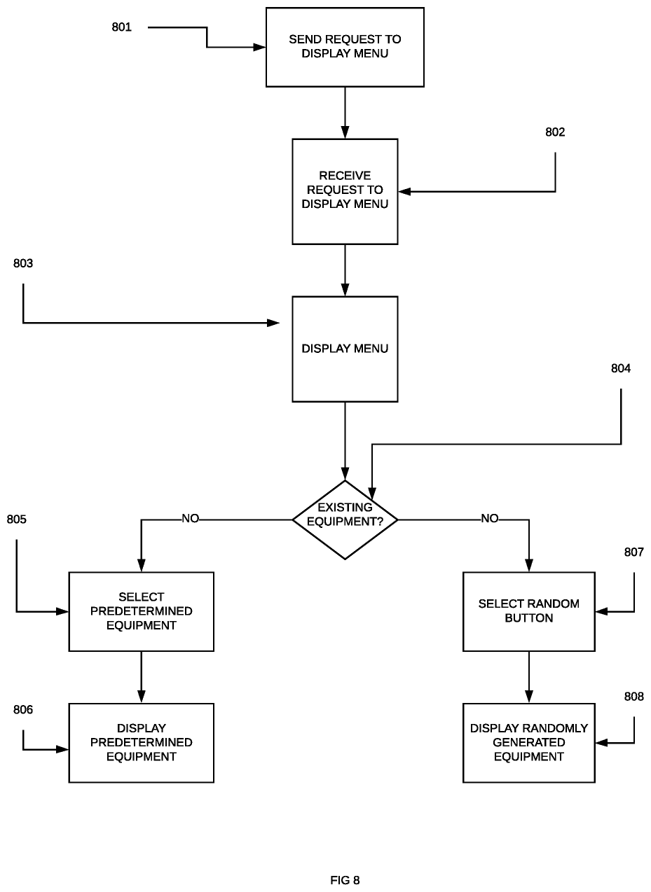

FIG. 8 is a flow chart of a process for an end user to display a vehicle, component, or subcomponent on a menu, according to an embodiment of the invention. In an embodiment where a user desires to display a menu, at 801 user sends a request to a processor to display the menu. The processor receives the request, at 802, and sends the requested menu to be displayed on the end-user device at 803.

At 804, the end user can decide if they want to access an existing vehicle, component, or subcomponent. If not, at 805, the user can select a preconfigured vehicle, component, or subcomponent, which can then be displayed at 806. As an example, if an end user has selected an existing vehicle, the end user can still select a preconfigured component to install on the existing vehicle.

At 807, if the end user does not want to use or access an existing piece of equipment, the end user can select a randomly or quasi-randomly generated vehicle, component, or subcomponent, which is then displayed at 808. In an embodiment, the menu will include a function that allows an end user to select a randomly or quasi-randomly generated vehicle, component, or subcomponent. In an embodiment, if an end user desires to generate a randomly or quasi-randomly generated vehicle, the user can use a visual representation of a button to select such a vehicle, component, or subcomponent. In another embodiment, an end user can input a command using a command line interface to randomly or quasi-randomly generate a vehicle.

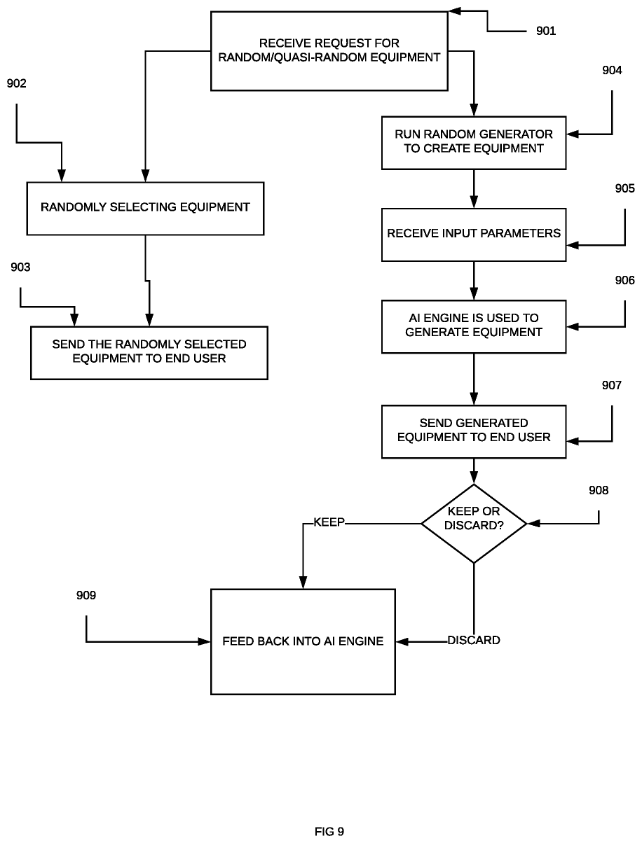

FIG. 9 is a flow chart that describes randomly generating equipment (a vehicle, component, or subcomponent), according to an embodiment. At 901, a processor receives a request for a randomly or quasi-randomly selected vehicle, component or subcomponent. At 902, the processor uses a random generator to select a complete vehicle, component, or subcomponent from a stored inventory of vehicles, components, or subcomponents. At 903, the processor sends the randomly or quasi-randomly selected vehicle, component, or subcomponent to be displayed to the end user.

In an embodiment, at 904, upon receiving a request for a random vehicle, the processor runs a random generator, which generates to a random or quasi-random combination of components and subcomponents which are used by the processor to generate the vehicle.

In an embodiment, the randomly or quasi-randomly generated vehicle, components, or subcomponents can be generated and combined within predetermined parameters such that colors, patterns, shapes, and other attributes match one another within certain rules. In an embodiment, at 905, the processor receives input parameters from an end user, or other party, that can include the end user's age, gender, favorite color, favorite type of vehicle, or any other appropriate parameter. One skilled in the art will understand that the input parameters can be received by the processor (input by a party) at any stage of the process. In an embodiment, the parameters are input by an end user through the menu displayed on the end user's device. At 906, the processor inputs those parameters into a form of artificial intelligence mechanism or engine to generate a piece of equipment that is appropriate for the end user. At 907, the generated equipment is sent to the end user to be displayed on the end-user device.

At 908, the end user will then decide to save or discard the generated equipment. The decision to save or discard can, at 909, be fed back into the artificial intelligence mechanism for future use.

One skilled in the art will understand that the random or quasi-random generator can include additional parameters for presenting a generated piece of equipment. For example, but not the only example, if the selected vehicle is blue, the processor, when generating a random components, may be limited to selecting components that are blue, or have colors that are complementary to blue. In another example of rules, if the vehicle selected is a monster truck, the processor may be constrained to selecting components that are appropriate for a monster truck. Such rules can be input by the user, or can be preconfigured into the processor by the owner of the processor, or by a third party.

The input parameters, along with the decision to keep or discard a given piece of generated equipment, along with the attributes of that equipment (e.g., the color, size, type, pattern, shape) can, in an embodiment, be fed back into the artificial intelligence engine and combined with data from other users, to create equipment that is appropriate for, and likely accepted by, the relevant end user.

In embodiments of the present invention, it is not only vehicle and racetracks that can be configured and/or created. Avatars can also be configured and/or created. Similar to creating virtual vehicle, virtual tracks, and/or their components, and subcomponents, respectively, in an embodiment, one can use the system to create avatars for drivers, pilots, astronauts, sailors, or other characters, each of which may be used in the virtual world. For example, the configurator can supply a design menu to select an avatar, or portion thereof (including but not limited to clothing, accessories, facial and body features, hair styles). In an embodiment, the avatar can be created and/or modified using the design menu. The avatar (or portion thereof) can be displayed in and/or out of a virtual vehicle, can be shared, purchased, and any other actions shown by the flow charts with regard to vehicle and vehicle parts.

One skilled in the art will understand, in the context of embodiments of the invention, that the term “a combination of” includes zero, one, or more, of each item in the list of items to be combined.

For the purposes of the present invention, the term computer program or computer code includes software, firmware, middleware, and any code in any computer language in any configuration, including any set of instructions or data intended for, and ultimately understandable by, a computing device.

One skilled in the art will understand that the order of elements described in each figure is given by way of example only. In an embodiment, the order of elements performed can be changed in any practicable way. For example, one skilled in the art will understand that the saving of the new vehicle, component, or sector at 301 and 210 in FIG. 2 are optional. In an embodiment, the new vehicle, component, or sector is not saved. In another embodiment, the new vehicle, component, or sector is saved, but at a different point in the flow.

In some embodiments, the processes in FIGS. 2-7, or any portion or combination thereof, can be implemented as software modules. In other embodiments, the processes in FIGS. 2-7 or any portion or combination thereof, can be implemented as hardware modules. In yet other embodiments, FIGS. 2-7, any portion or combination thereof, can be implemented as a combination of hardware modules, software modules, firmware modules, or any form of program code.

While certain embodiments have been shown and described above, various changes in form and details may be made. For example, some features of embodiments that have been described in relation to a particular embodiment or process can be useful in other embodiments. Some embodiments that have been described in relation to a software implementation can be implemented as digital or analog hardware. Furthermore, it should be understood that the systems and methods described herein can include various combinations and/or sub-combinations of the components and/or features of the different embodiments described. For example, types of verified information described in relation to certain services can be applicable in other contexts. Thus, features described with reference to one or more embodiments can be combined with other embodiments described herein.

Although specific advantages have been enumerated above, various embodiments may include some, none, or all of the enumerated advantages. Other technical advantages may become readily apparent to one of ordinary skill in the art after review of the following figures and description.

It should be understood at the outset that, although exemplary embodiments are illustrated in the figures and described above, the present disclosure should in no way be limited to the exemplary implementations and techniques illustrated in the drawings and described herein.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

We claim:

1. A method comprising:
sending by a first party to a computer processor, a log-in identifier to access a virtual garage stored in an online database, the virtual garage containing computer code representing at least one vehicle stored in the virtual garage, the at least one vehicle being comprised of a plurality of components;
sending by the first party to the computer processor a request to display the at least one vehicle in the virtual garage;
selecting a replacement component for at least one of the plurality of components;
sending by the first party to the computer processor, a instructions to replace the at least one of the plurality of components with the at least one replacement component to create a new vehicle;
displaying on an end-user device, the new vehicle.

2. The method of claim 1, wherein selecting a replacement for at least one of the plurality of components includes selecting a replacement component from a menu of preconfigured replacement components.

3. The method of claim 1, wherein selecting a replacement for at least one of the plurality of components includes sending a request for a randomly generated replacement component.

4. The method of claim 1, wherein selecting a replacement for at least one of the plurality of components includes sending instructions to modify at least one component in the plurality of components.

5. The method of claim 1, further comprising:
sending to the computer processor from the first party, a request to save the new vehicle to an online database;
sending instructions to perform at least one of the following function in the list of functions: share, purchase, and further modify the new vehicle.

6. The method of claim 1, further comprising:
sending from a user device, instructions to share the new vehicle with a second party;
sending from the user device, instructions to create an online message including an image of the new vehicle; and
sending from the user device instructions to send the online message to the second party.

7. The method of claim 6, wherein the instructions include a request for the second party to purchase the new vehicle for the benefit of at least one of the first party and the second party.

8. The method of claim 1, wherein the at least one vehicle represents a physical toy vehicle owned by the first party.

9. The method of claim 1, wherein the at least one vehicle represents a virtual vehicle.

10. A method comprising:
receiving at a computer processor from a first party, a log-in identifier to access a virtual garage stored in an online database, the virtual garage containing computer code representing at least one vehicle stored in the virtual garage, the at least one vehicle being comprised of a plurality of components;
receiving at the computer processor a request to display the at least one vehicle;
sending data to display, on an end-user device, the at least one vehicle;
receiving at the computer processor from the first party, a selection of at least one of the plurality of components;
receiving at the computer processor from the first party, a request for at least one replacement component;
receiving at the computer processor from the first party, a request to replace the at least one of the plurality of components with the at least one replacement component to create a new vehicle;
modifying the computer code in the database to create the new vehicle;
sending instructions to display, on the end-user device, the new vehicle.

11. The method of claim 10, further comprising:
receiving at the computer processor from the first party, a request to purchase the new vehicle;
executing at the computer processor computer instructions to create an online purchase workflow;
at the computer processor payment information for the new vehicle; and
updating the online database to include the new vehicle in the end user's virtual garage.

12. The method of claim 10, further comprising:
receiving at the computer processor, instructions to share the new vehicle with a second party;
sending instructions to create an online message including an image of the new vehicle; and
sending instructions to send the online message to the second party.

13. The method of claim 12, wherein the online message includes user instructions to purchase the new vehicle.

14. The method of claim 11, further comprising:
determining at the computer processor, if the new vehicle has been purchased;
if the new vehicle has been purchased, generating a message to a second party inviting the second party to join a race against the new vehicle.

15. The method of claim 11, further comprising:
determining at the computer processor, if the new vehicle has been purchased;
if the new vehicle has been purchased, generating a message to enter the new vehicle into a virtual vehicle show.

16. The method of claim 10, wherein the at least one vehicle represents a physical toy vehicle owned by the first party.

17. The method of claim 10, wherein the at least one vehicle represents a virtual vehicle.

18. A method comprising:
receiving, at a computer processor, input parameters for an artificial intelligence based random vehicle generation system;
receiving, from a first party, a request for a randomly generated vehicle for display in a virtual garage;
running the random vehicle generation system to create the randomly generated vehicle, the randomly generated vehicle being based on the input parameters;
sending the randomly generated vehicle to the end user for display.

19. The method of claim 21, further comprising:
receiving a signal that a user has saved the randomly generated vehicle;
feeding the decision to save the randomly generated vehicle in the signal back into the random vehicle generation system for use in randomly generating a subsequent vehicle.

20. The method of claim 21, further comprising:
receiving a signal that a user has discarded the randomly generated vehicle;
feeding the decision in the signal back into the random vehicle generation system for use in randomly generating a subsequent vehicle.
